(19) United States
(12) Patent Application Publication
(10) Pub. No.: US 2005/0192680 A1
(43) Pub. Date: Sep. 1, 2005

(54) System and method for optimizing global set points in a building environmental management system

(76) Inventors: Mark Cascia, Barrington, IL (US); Osman Ahmed, Hawthorne Woods, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/001,397

(22) Filed: Dec. 1, 2004

Related U.S. Application Data
(60) Provisional application No. 60/548,675, filed on Feb. 27, 2004.

(51) Int. Cl. G05B 13/02; G05B 13/00; G05B 15/00; G05B 21/00; G05D 23/00

(52) U.S. Cl. 700/29; 700/49; 700/50; 700/276

(57) ABSTRACT

A system generates optimal global set points for an environmental management system. The system comprises a system model for modeling components of a thermal plant, an objective function for modeling a parameter of the thermal plant, and an optimization engine for optimizing the parameter modeled by the objective function. The system model is coupled to an input data collector for receiving building data and weather data corresponding to a particular site. The system model includes models for thermal plant system components that may be implemented using classical models or artificial intelligence models. Classical models are those models that are implemented using linear programming, unconstrained non-linear programming, or constrained non-linear programming methodologies. The artificial intelligence models are those models that may be implemented using a fuzzy expert control system with crisp and fuzzy rules, genetic algorithms for optimization, or neural networks.

This application claims the benefit of U.S. Provisional Patent Application Ser. No. 60/548,675, filed on Feb. 27, 2004 which is incorporated herein by reference.

### FIELD OF THE INVENTION

This invention relates to systems for generating control parameters for building environmental management systems and, more particularly, to systems for determining set points used to regulate the operation of a building environmental management system.

### BACKGROUND OF THE INVENTION

Most commercial properties include a number of building systems that monitor and regulate various functions of the building for the comfort and well-being of the tenants. These building systems include security systems, fire control systems, and elevator systems. One prevalent and important building system is the environmental management system.

An environmental management system is used to regulate the temperature and flow of air or water throughout a building. The air conditioning system for a large commercial building typically includes one or more chillers for producing chilled water and one or more boilers for producing hot water. The chilled water and hot water is pumped to cooling and heating coils, respectively, which are located in the air distribution system duct work. Air handler fans blow air across a cooling or heating coil in a duct system to condition the air that is directed by the duct work to the various rooms of a building. Dampers are located within the duct system and are controlled to vary the amount of air going into a room or space. The dampers are controlled through a range of movement from being 100% open to 0% open, i.e., closed, by actuators. Also, the speed of a motor that drives a fan is controlled to regulate fan speed and, correspondingly, air flow in the system. An important component of a building environmental management system is the control system that varies the fan motor speed and the position of the various dampers to maintain pressure and flow rate set points for the system.

In a co-pending patent application that was filed on Sep. 23, 2003 and is entitled “System and Method for Developing and Processing Building System Control Solutions” having Ser. No. 10/668,949 which is commonly owned by the assignee of this patent, the disclosure of which is hereby expressly incorporated by reference into this patent in its entirety, a remote system is described for generating environmental management system control programs that are downloaded to buildings for implementation on the building environmental management systems. These control programs maintain a group of selected global set points that regulate the environmental conditions for a building.

The global set points may be set by a real-time operating system that is an integral component of a building automation system or environmental management system. However, the real-time operating system is typically site specific and does not generate global set points that are generally applicable to environmental management systems. In the control program system described in the co-pending application referenced and incorporated above, a more general approach is desired to offload the task of set point determination to a central site. This approach promises a number of advantages. For one, a central site determination of global set points for a building automation system reduces the need for advanced engineering skills or tools at each building. Building engineers do not typically have the time to develop the models and programs required for generating global set points. Instead, their focus is on the operation and maintenance of the thermal plant that provides the conditioned air for the building. However, the development of building control strategies that significantly reduce the energy consumed by the thermal plant requires the application of advanced engineering skills and tools.

Studies have shown that global set point optimization for thermal plants can result in energy savings of 5-10% of a building's annual energy consumption in kilowatt-hours (KWH). In order to provide the capability for determining optimized global set points without requiring each building to have advanced engineering skills and tools, data from the building thermal plant and environment needs to be provided to a central site. There, the data may be used to generate optimized global set points. However, known systems for generating global set points are directed to statistical determinations of set points based on the mining of historical data for specific building characteristics and conditions. Maintaining a system for the generation of optimized set points for each building coupled to the central site is too resource intensive. That is, merely transferring a real-time system for generating optimized global set points for a particular building to a central site results in multiple systems and engineering teams at the central site. Centralization should result in efficient resource utilization and reduced overhead. Furthermore, the delay in transferring data from a building to a central site for processing by a real-time system may result in the generation of erroneous global set points or the production of set points applicable to building system conditions that no longer exist.

Consequently, there is a need for a system that generates optimized global set points at a central site without requiring the system be configured for a specific building.

A need exists for a system that generates optimized global set points at a central site without duplicating advanced engineering tools and skills at the site.

A need exists for a system that generates optimized global set points at a central site that are applicable to a remotely located building without requiring real-time data and processing for the generation of the optimized global set points.

### SUMMARY OF THE INVENTION

A system and method operating in accordance with the principles of the present invention overcome the limitations of previously known systems for optimizing global set points. The system comprises a system model for modeling components of a thermal plant, an objective function for modeling a parameter of the thermal plant, and an optimization engine for optimizing the parameter modeled by the objective function. The system may also include an input data collector for receiving building data and weather data so the data is provided to the system model. Such an input data collector is described in the co-pending application that was referenced and incorporated in its entirety above.

The system model of the inventive system may include a chilled water plant model or a hot water plant model. The system model includes models for thermal plant system components that may be implemented using classical models or artificial intelligence models. Classical models are those models that are implemented using linear programming, unconstrained non-linear programming, or constrained non-linear programming methodologies. The artificial intelligence models are those models that may be implemented using a fuzzy expert control system with crisp and fuzzy rules, genetic algorithms for optimization, or neural networks. A preferred artificial intelligence model includes a neural network for modeling the thermal plant, an objective cost function for operating the thermal plant, and a genetic algorithm for the optimization engine that generates the optimized global set points for minimizing the cost operation of the thermal plant.

In one embodiment of the present invention, the system model is a fuzzy expert system for modeling the thermal plant, the objective function is a cost function for operating the thermal plant, and the optimization engine implements a genetic algorithm for generating optimized set points for minimizing the cost of operation of the thermal plant. When the mapping relationship between input values and output variables are known, they may be included in a fuzzy expert control system as crisp rules. In another embodiment of the present invention, the optimization engine generates optimized set points for a condenser water supply temperature, an output water supply temperature, and a coil discharge air temperature. The output water supply temperature may refer to either a chilled water supply or a hot water supply temperature. The system of the present invention may also include a transmitter for transmitting the global set points to a remote building environmental management system. Preferably, the transmitter is a server for sending the optimized set points over an open network, such as the Internet, to a building environmental management system at a remote building. However other communication methods, such as cellular or other phone or wireless communication methods, may be used to transfer optimized set points to a building environmental management system. Such transmission schemes are discussed in the co-pending patent application that was expressly incorporated by reference above.

The system model of the present invention may be coupled to the input data collector through an input for water supply and return temperatures, an input for condenser water supply and return temperatures, an input for thermal plant load, an input for water flow, an input for water thermal treatment power, an input for water pump power, and an input for air handler fan power. These data are collected at a remote building site at some sampling frequency. Preferably, the sampling frequency is less than one hour. The data may be smoothed with a median or mean average filter before being processed by the system plant.

The system model may also include a plurality of component models that generate characterization factors for the component models. Characterization factors are sets of constants used in the component models implemented with classical optimization models. These factors are determined to calculate the power consumption of the cooling or heating thermal plant. A regression analyzer may also be included for generating functional relationships between the characterization factors and a building load and the optimization engine receives the functional relationships for use in generating the optimal global set points.

A method for optimizing global set points for a building environmental management system begins by receiving building data and weather data and modeling components of a thermal plant with the building and weather data. The responses of the modeled components are used by an objective function to model an operational parameter of the thermal plant, such as cost. The objective function and responses of the thermal plant components are used to optimize the set points generated by the modeled thermal plant components. These optimized set points may be transmitted to a remote building environmental management system for incorporation in its operation. The method of the present invention may be used to model a chilled water plant or a hot water plant model.

The method of the present invention may be implemented using classical models or artificial intelligence models. As noted above, classical models may be implemented using linear programming, unconstrained non-linear programming, or constrained non-linear programming methodologies. Artificial intelligence models, as discussed above, may be implemented using a fuzzy expert control system with crisp and fuzzy rules, genetic algorithms for optimization, or neural networks. When a neural network is used to model the method of the present invention, the neural network is trained to model the thermal plant, an objective function of the plant, such as cost, is selected, and optimized set points for minimizing the operation of the thermal plant are generated. The method of the present invention may be-used to generate-optimized set points for a condenser water supply temperature, an output water supply temperature, and a coil discharge air temperature, for example. Again, the output water supply temperature may refer to a chilled water or hot water supply temperature.

The method of the present invention processes water supply and return temperatures, condenser water supply and return temperatures, thermal plant load, water flow, water thermal treatment power, water pump power, and air handler fan power to generate the optimized set points. Water thermal treatment power refers to chiller or boiler power. When classical optimization methods are used to model the thermal plant components, the method of the present invention may also use these data to generate characterization factors for the thermal plant components;. Functional relationships are generated for the characterization factors and a building load, and the optimal global set points are generated with reference to the characterization factors and their corresponding functional relationships.

Consequently, the system and method of the present invention generate optimized global set points at a central site without requiring the system be configured for a specific building.

The system and method of the present invention generate optimized global set points at a central site without duplicating advanced engineering tools and skills at the site.

The system and method of the present invention generate optimized global set points at a central site that are applicable to a remotely located building without requiring real-time data and processing for the generation of the optimized global set points.

These and other advantages and features of the present invention may be discerned from reviewing the accompanying drawings and the detailed description of the invention.

### BRIEF DESCRIPTION OF THE DRAWINGS

The present invention may take form in various components and arrangement of components and in various methods. The drawings are only for purposes of illustrating exemplary embodiments and alternatives and are not to be construed as limiting the invention.

FIG. 1 is a block diagram of a system incorporating the principles of the present invention for generating optimized set points for operation of a building environmental management system;

FIG. 2 is a block diagram of an implementation of the system shown in FIG. 1 using classical optimization techniques;

FIG. 3 is a block diagram depicting the process of training a neural network that may be used to implement the system model shown in FIG. 1;

FIG. 4 is a block diagram of the system shown in FIG. 1 using a neural network for the system model and genetic algorithm for the optimization engine; and

FIG. 5 is a flow diagram of an exemplary process for optimizing global set points.

### DETAILED DESCRIPTION OF THE INVENTION

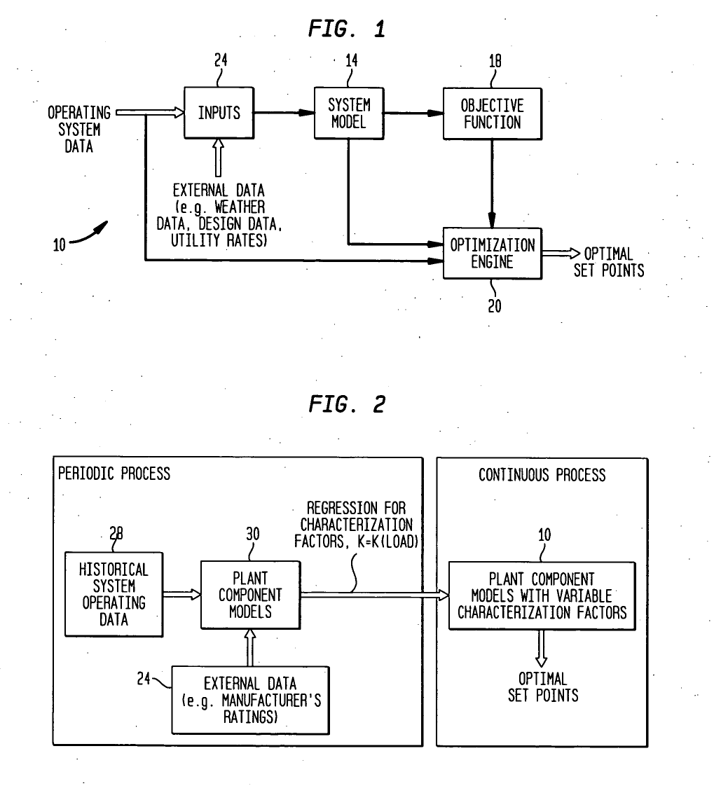

A system for optimizing global set points for use in a building environmental management system is shown in FIG. 1. The system 10 comprises a system model 14 for modeling components of a thermal plant, an objective function 18 for modeling a parameter of the thermal plant, and an optimization engine 20 for optimizing the parameter modeled by the objective function. The system 10 may also include an input data collector 24 for receiving building data and weather data so the data is provided to the system model. Such an input data collector is described in the co-pending application that was referenced and incorporated above.

The thermal plant modeled by the system model of the system 10 may be a chilled water plant model or a hot water plant model. In the discussion below, the system 10 generates optimized set points for a condenser water supply temperature, an output water supply temperature, and a coil discharge air temperature. However, other set points may be optimized in accordance with the principles of the present invention, such as, the discharge temperature from packaged cooling units, the variable speed fan discharge static pressure, the variable speed pump differential pressure for the most remote terminal unit in the building system, or the load at which the next chiller should be brought online to minimize daily operating costs.

The system model 14 includes models for thermal plant system components that may be implemented using classical models or artificial intelligence models. Classical models are those models that are implemented using linear programming, unconstrained non-linear programming, or constrained non-linear programming methodologies. Classical models are computer programs that implement a set of mathematical equations for modeling the components of the thermal plant. The objective function is a computer program that implements a polynomial equation for plant power as a function of the change in the temperature of chilled water, although other thermal plant parameters may be selected. The optimization engine in a classical embodiment is a computer program that computes a minimum using the first derivative of the objective function with respect to the selected thermal plant parameter as the criterion. In one embodiment of the present invention, the system plant is implemented on a computer having a Pentium processor or equivalent operating at 1.8 GHz. The computer is supported with a 60 MB hard drive and 128 MB of SRAM. The programs for implementing the system model 14, the objective function 18, and the optimization engine 20 may be written using the software tool MatLab®, although other software packages may be used to implement the components of system 10 for the classical optimization approach.

The artificial intelligence models are those models that may be implemented using a fuzzy expert control system with crisp and fuzzy rules, genetic algorithms for optimization, or neural networks. One embodiment of the artificial intelligence model includes a neural network for modeling the thermal plant, the objective function for operating the thermal plant is a cost function, and the optimization engine implements a genetic algorithm for generating optimized set points for minimizing the cost operation of the thermal plant. In another embodiment of the present invention, the system model is a fuzzy expert system for modeling the thermal plant, the objective function is a cost function for operating the thermal plant, and the optimization engine implements a genetic algorithm for generating optimized set points for minimizing the operation of the thermal plant. When the mapping relationship between input values and output variables are known, they may be included in a fuzzy expert control system as crisp rules. The reader should note that if the relationship between the inputs and outputs of a thermal plant is a known mathematical function, a neural network is not needed for the system model 14. In one embodiment of the present invention, the optimization engine generates optimized set points for a condenser water supply temperature (for chilled water plants only), an output water supply temperature, and a coil discharge air temperature, although other global set points may be used as noted above. A computer system having the resources noted above may also be used for the artificial intelligence implementation of system 10. The objective function and optimization engine may be implemented in MatLab®, for example, as previously noted. However, the neural network used to implement the system model 14 is preferably implemented with an off-the-shelf neural network package.

The system 10 may also include a transmitter for transmitting the global set points to a remote building environmental management system. Preferably, the transmitter is a server for sending the optimized set points over an open network, such as the Internet, to a building environmental management system at a remote building. However, other communication methods, such as cellular or other phone or wireless communication methods, may be used to transfer optimized set points to a building environmental management system. Such transmission schemes are discussed in the co-pending patent application that was expressly incorporated by reference above.

In a classical implementation of the system 10, the mathematical relationships between a key thermal plant input, such as the chilled water differential temperature, and the thermal plant outputs, such as chiller power, chilled water pumps, and air handlers, are used to determine optimal set points. These mathematical relationships and thermal plant characterization factors, which may be determined through regression analysis of building data collected from a remote site, are used to define an optimization function that is optimized by the optimization engine to determine optimal set points for the thermal plant. An example of a classical implementation of system 10 may be understood with reference to the following description of determining global set points for a cooling or heating thermal plant.

Building data collected for either a cooling or heating thermal plant includes chilled water or hot water supply and return header temperatures, condenser water supply and return header temperatures (for chilled water plants only), chiller plant or boiler plant loads, chilled water or hot water flow rates, chiller or boiler power, chilled water or hot water pump power, and air handler fan power. The component models for chiller, boiler, chilled water and hot water pump, and air handler fan implemented in system model 14 are used with the collected building data to calculate the characterization factors for the chillers, boilers, chilled and hot water pumps, and air handler fans. Regression analysis is performed off-line on a computer using a program such as MatLab® or a similar engineering tool to determine the functional relationships of the characterization factors with building load. For example, the following equations apply for a cooling plant:

$${P}_{tot} = {P}_{ch . des} ( {a}_{0} + {a}_{1} x + {a}_{2} {x}^{2} + {a}_{3} y + {a}_{4} {y}^{2} + {a}_{5} xy ) + {{K}_{CHW pump} ( \frac{1}{Δ {T}_{chw}} )}^{3} + {{K}_{CW pump} ( \frac{1}{Δ {T}_{cw}} )}^{3} + {{K}_{AHU fan / cc} ( \frac{1}{Δ {T}_{chw}} )}^{3} + {P}_{CT fans} {G}_{twr}^{3} \\ where \text{:} x = ( \frac{C}{Dload} ) ( CHW flow ) Δ {T}_{chw} \\ y = \frac{{T}_{cwr} - {T}_{chws}}{D} = \frac{{T}_{cwr} - {T}_{chwr} + Δ {T}_{chw}}{D} \qquad ( 1 )$$

A classical optimization of these equations determines the following for a chiller plant:
a₀=a₀(load)
a₁=a₁(load)
a₂=a₂(load)
a₃=a₃(load)
a₄=a₄(load)
a₅=a₅(load)
K_{CHW pump}=K_{CHW pump}(load)
K_{AHU fan}=K_{AHU fan}(load) (2)

These characterization functions, along with the plant component models implemented by the system model 14, are used by the optimization engine 20 to generate a set of global set points for some defined operational period. These set points are transmitted to an environmental management system for implementation. This process is shown in FIG. 2. In that process, a computer system 30 implementing the component models discussed below receives external data 24, such as manufacturer ratings, and historical data 28 regarding the operation of an environmental management system. The component models are used to calculate the characterization factors through regression analysis. The characterization factors are used in system 10 to implement the system model 14 so that the objective function 18 may be minimized and the optimal global set points generated by the optimization engine 20. This process is continual with the characterization factors being updated on a periodic basis by the offline process implemented by the system 30.

The method of solving for the optimal chilled water, condenser water, and hot water supply temperatures described below fits generally into unconstrained non-linear programming. The problem of minimizing or maximizing a sufficiently smooth nonlinear function ƒ(x) is n variables x^{T}=[x₁, x₂, . . . ,xₙ], with no restrictions on x. At a minimum or maximum x*, it must be true that the gradient of ƒ vanishes:
∇ƒ(\vec{x}*)=0 (3)
Thus, x* is in the set of all solutions of this system of n generally nonlinear equations.
Plant Component Models

Classical optimization methods may be used to calculate the optimal chilled water or hot water delta T (ΔT_{chw} or ΔT_{hw}), condenser water delta T (ΔT_{cw}), and the air-side delta T (ΔTₐᵢᵣ) from mathematical models of the chillers, boilers, pumps, cooling towers, and air handler fans. These models may be used to minimize the total instantaneous chilled water plant power or hot water plant power. That is, for the cooling plant the total power to minimize is:
P_{Tot}=P_{comp}+P_{CHW pump}+P_{CW pump}+P_{CT fans}+P_{AHU fan/cc} (4)
Where
P_{Tot}=the total instantaneous chilled water plant power consumption
P_{comp}=the instantaneous power consumption of the chiller compressors
P_{CHW pump}=the instantaneous power consumption of the chiller water pumps
P_{CW pump}=the instantaneous power consumption of the condenser water pumps
P_{CT fans}=the instantaneous power consumption of the cooling tower fans
P_{AHU fan/cc}=the instantaneous power consumption of the air handler fans blowing across the cooling coils. For the heating plant, the total power to minimize is:
   P_{Tot}=P_{boiler}+P_{HW pump}+P_{AHU fan/hc} (5)
   Where
P_{boiler}=the instantaneous power consumption of the boilers
P_{HW pump}=the instantaneous power consumption of the hot water pumps
P_{AHU fan/hc =the instantaneous power consumption of the air handler fans blowing across the heating coils.}

The components of the chilled water plant under analysis are the chillers, cooling towers, chilled water pumps (primary, and any applicable secondary pumps), condenser water pumps, and air handler fans blowing across cooling coils. The components of the hot water plant under analysis are the boilers, hot water pumps, and air handler fans blowing across the heating coils.

Chiller Power Model

Two chiller models may be used in the system model 14 that relate the power of the chiller as a function of variables that are typically measured in an environmental management system. For a first approximation, the chiller power can be modeled as directly proportional to the delta T (return minus supply water temperature) of the chilled water through the evaporator:
Pₜₕ=K_{ch}ΔT_{chw} (6)
Where K_{ch} is a characterization constant for a given load. K_{ch} will need to be calculated from chiller power and ΔT_{chw} measurements for each step in load.

A preferred model for use in system model 14 for modeling chiller part-load performance is one that is quadratic in two variables:

$$\frac{{P}_{ch}}{{P}_{ch . des}} = {a}_{0} + {a}_{1} x + {a}_{2} {x}^{2} + {a}_{3} y + {a}_{4} {y}^{2} + {a}_{5} xy \qquad ( 7 )$$

Where x is the ratio of the load to a design load, y is the leaving condenser water temperature minus the leaving chilled water temperature, divided by a design value, P_{ch} is the actual chiller power consumption, and P_{des} is the chiller power associated with the design conditions. The empirical coefficients of the above equation (a₀, a₁, a₂, a₃, a₄, a₅) may be determined with a linear least-squares curve-fitting technique that is applied to measured performance data.
Pump Power Model

There are three different classifications of pumps in the cooling or heating plant—chilled water pumps, condenser water pumps, and hot water pumps. The models that may be implemented in systemi model 14 for each of these pumps are similar:

$${P}_{CHW pump} = {K}_{CHW pump} \cdot {( \frac{1}{Δ {T}_{chw}} )}^{3} \\ {P}_{CW pump} = {K}_{CW pump} \cdot {( \frac{1}{Δ {T}_{cw}} )}^{3} \\ {P}_{HW pump} = {K}_{HW pump} \cdot {( \frac{1}{Δ {T}_{hw}} )}^{3} \qquad ( 8 )$$

where
P_{CHW pump}=the power consumption of the chilled water pumps,
P_{CW pump}=the power consumption of the condenser water pumps,
P_{HW pump}=the power consumption of the hot water pumps.
   K_{CHW pump}, K_{CW pump}, and K_{HW pump} are characterization factors that are determined from measurements of pump power and ΔT_{chw}, ΔT_{hw}, and ΔT_{cw} at each quasi-steady-state load.
   Air-Handler Fan Power Model

The air-handler fan power model implemented in system model 14 is similar to the pump power model, except for different characterization factors:

$${P}_{AHU fan / cc} = {K}_{AHU fan / cc} \cdot {( \frac{1}{Δ {T}_{chw}} )}^{3} = {K}_{AHU fan / cc}^{′} \cdot {( \frac{1}{Δ {T}_{air}} )}^{3} \\ {P}_{AHU fan / hc} = {K}_{AHU fan / hc} \cdot {( \frac{1}{Δ {T}_{hw}} )}^{3} = {K}_{AHU fan / hc}^{′} \cdot {( \frac{1}{Δ {T}_{air}} )}^{3} \qquad ( 9 )$$

Note that the second half of Equations (9) are true at each quasi-steady-state load characterization factors, K_{AHU fan/cc}, K_{AHU fan/hc}, K′_{AHU fan/cc}, and K′_{AHU fan/hc} are calculated from measured values of air handler power and ΔT_{chw}, ΔTₐᵢᵣ′, and ΔT_{hw}. The second half of these equations mean that once the optimum delta T of the hot water or chilled water is determined, the optimum delta T of the air across the coil ΔT_{air opt} may be determined. The optimum discharge air temperature ΔT_{coil discharge opt} is then calculated from the measured inlet (mixed) air temperature to the coil as follows:
ΔTₐᵢᵣₒₚₜ=T_{ccinlet}−T_{ccdischarge} (10) [symbol]
T_{ccdischarge opt}=T_{cclinlet}−ΔTₐᵢᵣₒₚₜ (11)
Cooling Tower Model

The operation of the cooling tower under optimal set point control is assumed to obey a known relationship that relates the part-load ratio in the chilled water loop and the chiller and tower design parameters with the relative air flow of the cooling tower. The relative air flow of the cooling tower is defined as the tower air flow divided by the maximum tower air flow with all tower cells operating at maximum speed. This expression for the tower relative airflow results in minimal power consumption for the chiller and tower combined.
G_{twr}=1−β_{twr}(PLR_{twr,cap}−PLR) for PLR_{free cooling}<PLR<PLR_{twr,cap} (12)
and
G_{twr}=4·PLR└1−β_{twr}(PLR_{twr,cap}−PLR_{free cooling})┘for 0<PLR<PLR_{free cooling} (13)
where
G_{twr}=relative tower air flow,
PLR=part-load ratio; the chilled-water load divided by the total chiller cooling capacity,
β_{twr}=slope of the relative tower air flow (G_{twr}) versus the part-load ratio (PLR) function,
PLR_{twr,cap}=the part-load ratio (value of PLR) at which the tower operates at its capacity (G_{twr}=1).
PLR_{free cooling}=the part-load ratio at which it becomes feasible to utilize “free cooling.” This part-load ratio typically has a value of about 0.25.

Because the air-side system resistance curve across the cooling tower remains static under varying load conditions, the cooling tower fans obey the fan laws. This allows a relationship between tower air flow and tower power consumption to be developed, depending on the type of lower in question.

Variable-Speed Towers

The power consumption for variable-speed tower fans can be modeled with reference to the tower relative air flow as:
P_{CT fans}=P_{CT des}(G_{twr})³ (14)
Variable or Multi-Speed Towers

The power consumption model used in system model 14 for variable or multi-speed towers can be written as:
P_{CT fans}=P_{CT des}γ³ (15)
where
γ=the calculated tower relative air flow G_{twr} at a given speed condition.

For example, the calculated relative air flow for the slow speed of a two-speed tower would be:

$$γ = \sqrt[3]{\frac{{P}_{slow}}{{P}_{fast}}} \qquad ( 16 )$$

where
P_{slow}=the rated tower power at slow speed,
P_{fast}=the rated tower power at fast speed.
   Cooling Plant Power Model

Combining Equations (4), (7), (8), (9), and (14) provides the expression for the total cooling plant power:

$${P}_{tot} = {P}_{ch . des} ( {a}_{0} + {a}_{1} x + {a}_{2} {x}^{2} + {a}_{3} y + {a}_{4} {y}^{2} + {a}_{5} xy ) + {{K}_{CHW pump} ( \frac{1}{Δ {T}_{chw}} )}^{3} + {{K}_{CW pump} ( \frac{1}{Δ {T}_{cw}} )}^{3} + {{K}_{AHU fan / cc} ( \frac{1}{Δ {T}_{chw}} )}^{3} + {P}_{CT fans} {G}_{twr}^{3} \\ where \text{:} x = ( \frac{C}{Dload} ) ( CHW flow ) Δ {T}_{chw} \\ y = \frac{{T}_{cwr} - {T}_{chws}}{D} = \frac{{T}_{cwr} - {T}_{chwr} + Δ {T}_{chw}}{D} \qquad ( 17 )$$

Where the chilled water flow CHW flow is a measured variable, and
T_{cwr}=temperature of the condenser water return (a measured variable),
T_{chwr}=temperature of the condenser water return (a measured variable),

And C and D are constants.

Optimal Chilled Water Delta T

The optimal chilled water delta T, ΔT_{chw opt}; determined by the optimization engine 20 can be obtained by taking the first derivative of Pₜₒₜ with respect to ΔT_{chw} in Equation (17), setting it equal to zero, and solving for ΔT_{chw opt}. Note that when the first derivative of Pₜₒₜ with respect to ΔT_{chw} is taken, the partial derivative of P_{Tot} must be taken with respect to ΔT_{chw} since P_{Tot} is a function of three variables, ΔT_{chw}, ΔT_{cw}, and G_{twr}, and the chain rule is used to differentiate the last term of the first line of Equation (17), since G_{twr} is a function of ΔT_{chw}. The resulting equations are shown as Equations (18) and (19) for different ranges of part-load ratio, PLR.

$$\begin{matrix}\begin{matrix}\frac{\partial {P}_{tot}}{\partial ( Δ {T}_{chw} )} = \frac{\partial {P}_{tot}}{\partial x} \cdot \frac{ⅆ x}{ⅆ ( Δ {T}_{chw} )} + \frac{\partial {P}_{tot}}{\partial y} \cdot \frac{ⅆ y}{ⅆ ( Δ {T}_{chw} )} + \frac{\partial {P}_{tot}}{\partial {G}_{twr}} \cdot \\ \frac{ⅆ {G}_{twr}}{ⅆ ( Δ {T}_{chw} )} - 3 \cdot ( {K}_{chw pump} + {K}_{fan} ) \cdot \\ ( \frac{CHW Flow}{C \cdot Dload} ) Δ {T}_{chw}^{- 4} \\ = 3 {P}_{CT des} {Γ [ {C}_{3} + {β}_{twr} ( \frac{CHW Flow}{C \cdot Dload} ) ]}^{2} Δ {T}_{chw}^{6} + \\ [ 2 {a}_{2} {{P}_{ch . des} ( \frac{CHW Flow}{C \cdot Dload} )}^{2} + \\ 2 {a}_{5} ( \frac{{P}_{ch . des} \cdot CHW Flow}{C \cdot Dload} ) + 2 {a}_{4} {P}_{ch . des} ] Δ {T}_{chw}^{5} + \\ \{ ( \frac{{P}_{ch . des} \cdot CHW Flow}{C \cdot Dload} ) [ {a}_{1} + {a}_{5} ( {T}_{cwr} - {T}_{chwr} ) ] + \\ {a}_{3} {P}_{ch . des} + 2 {a}_{4} ( {T}_{cwr} - {T}_{chwr} ) \} Δ {T}_{chw}^{4} - 3 \cdot \\ ( {K}_{chw pump} + {K}_{fan} ) \cdot ( \frac{CHW Flow}{C \cdot Dload} ) \\ = 0 for {PLR}_{free cooling} < PLR < {PLR}_{twr . cap}\end{matrix} \\ Or & ( 18 ) \\ \begin{matrix}\frac{\partial {P}_{tot}}{\partial ( Δ {T}_{chw} )} = 3 {P}_{CT des} {Γ [ 4 {C}_{2} ( \frac{CHW Flow}{C \cdot Dload} ) ]}^{2} Δ {T}_{chw}^{6} + \\ [ 2 {a}_{2} {{P}_{ch . des} ( \frac{CHW Flow}{C \cdot Dload} )}^{2} + \\ 2 {a}_{5} ( \frac{{P}_{ch . des} \cdot CHW Flow}{C \cdot Dload} ) + 2 {a}_{4} {P}_{ch . des} ] Δ {T}_{chw}^{5} + \\ \{ ( \frac{{P}_{ch . des} \cdot CHW Flow}{C \cdot Dload} ) [ {a}_{1} + {a}_{5} ( {T}_{cwr} - {T}_{chwr} ) ] + \\ {a}_{3} {P}_{ch . des} + 2 {a}_{4} ( {T}_{cwr} - {T}_{chwr} ) \} Δ {T}_{chw}^{4} - 3 \cdot \\ ( {K}_{chw pump} + {K}_{fan} ) \cdot ( \frac{CHW Flow}{C \cdot Dload} ) \\ = 0 for 0 < PLR < {PLR}_{free cooling}\end{matrix} & ( 19 )\end{matrix}$$

Optimal Condenser Water Delta T

The optimal condenser water delta T, ΔT_{cw opt}, determined by optimization engine 20 can be obtained by taking the first derivative of Pₜₒₜ with respect to ΔT_{cw} in Equation (17), setting it equal to zero, and solving for ΔT_{cw opt}. This process yields Equation (20). Again, the partial derivatives are obtained and the chain rule is used for determining this partial differentials.

$$\begin{matrix}\frac{\partial {P}_{tot}}{\partial ( Δ {T}_{cw} )} = \frac{\partial {P}_{tot}}{\partial x} \cdot \frac{ⅆ x}{ⅆ ( Δ {T}_{cw} )} + \frac{\partial {P}_{tot}}{\partial y} \cdot \frac{ⅆ y}{ⅆ ( Δ {T}_{cw} )} - \\ 3 {K}_{chw pump} Δ {T}_{cw}^{- 4} \\ = {P}_{ch . des} ( {a}_{3} + 2 {a}_{4} y + {a}_{5} x ) - 3 {K}_{cw pump} Δ {T}_{cw}^{- 4} \\ = 0\end{matrix} \qquad ( 20 )$$

Heating Plant Power Model

Combining Equations (4), (5), (8), and (9), yields the expression used by the system model 14 for modeling the total heating plant power:

$${P}_{tot} = {K}_{boiler} Δ {T}_{hw} + {{K}_{HW pump} ( \frac{1}{Δ {T}_{hw}} )}^{3} + \\ + {{K}_{AHU fan / hc} ( \frac{1}{Δ {T}_{hw}} )}^{3} \qquad ( 21 )$$

Optimal Hot Water Delta T

The optimal hot water delta T, ΔT_{hw opt}, determined by optimization engine 20 can be solved analytically by taking the first derivative of Equation (21), setting it equal to zero, and solving for ΔT_{hw opt}. This is expressed in Equation (22).

$$Δ {T}_{hw . opt} = \sqrt[4]{\frac{3 ( {K}_{hw pump} + {K}_{fan} )}{{K}_{boiler}}} \qquad ( 22 )$$

The solutions for the optimal values noted above provide the optimal global set points that are transmitted to a remote building environmental management system for regulation of the system.

Constrained Nonlinear Programming

A constrained nonlinear programming methodology may also be used for the classical implementation of the system 10. This type of system finds the maximum or minimum of a function ƒ(x) of n variables, subject to the constraints:

$$\vec{a} ( \vec{x} ) = [ \begin{matrix}{a}_{1} ( {x}_{1} , {x}_{2} , … , {x}_{n} ) \\ {a}_{2} ( {x}_{1} , {x}_{2} , … , {x}_{n} ) \\ … \\ {a}_{m} ( {x}_{1} , {x}_{2} , … , {x}_{n} )\end{matrix} ] = [ \begin{matrix}{b}_{1} \\ {b}_{2} \\ … \\ {b}_{m}\end{matrix} ] = \vec{b} \qquad ( 23 )$$

This problem may be transformed into an unconstrained problem by introducing the new function L(x):
L(\vec{x})=ƒ(\vec{x})+\vec{z}^{T}\vec{a} (\vec{x}) (24)
Where z^{T}=[λ₁, λ₂, . . . , λₘ] is the vector of Lagrange multipliers. Now the requirement that ∇L(y)=0, together with the constraints a(x)=b, give a system of n+m equations:
∇ƒ(\vec{x})+\vec{z}∇\vec{a}(\vec{x})=0 (25)
\vec{a}(\vec{x})=\vec{b}
For the n+m unknowns, x₁, x₂, . . . ,xₙ, λ₁, λ₂, . . . , λₘ must be satisfied by the minimum or maximum of x. The problem of inequality constraints is significantly more complicated in the nonlinear case than in the linear case.
Artificial Intelligence Optimization

In general, a fuzzy expert control system or a neural network may be used in the system model 14 in tandem with a genetic algorithm in optimization engine 20 to determine the optimal global set points required to minimize plant power consumption. If there is a known mathematical relationship between the inputs and outputs of a process, a physical model of the system is available and there is no need for a neural network model. In this case, the mathematical relationships between inputs and outputs would be defined as crisp rules in the fuzzy expert system. For the fuzzy expert system or neural network implementation of the system model 14, a model of future plant operating costs based on the current operating data and set of set points is designed. In the case of neural networks, multiple models may be designed. When the accuracy of the neural network models is proven through a neural network training process, a prediction process selects the best neural network model is doing the best. This capability is available in the KnowledgeScape™ Adaptive Optimization and Expert Control System software package noted above. A genetic algorithm program in the optimization engine 20 then generates a random set of set points and uses the neural network model to predict the future plant operating costs with these set points. If the future plant operating costs with these set points is less than the plant operating costs at the old set of set points, these potential solutions are passed onto the next generation, and another, more refined set of set points is generated. The process continues in this way until an optimal set of set points is found that minimize future plant operating costs. Once the optimal set of set points is found, these are passed to the environmental management system for implementation.

Neural Network Model Inputs and Optimization Process

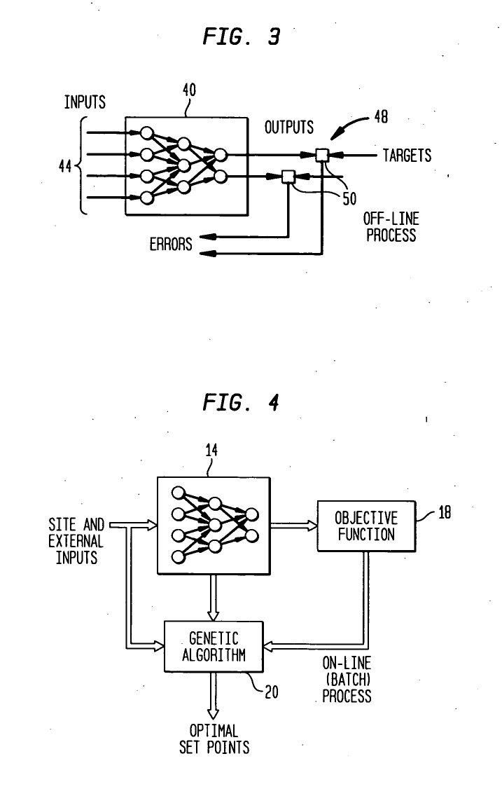

The design of a neural network requires design choices such as selecting the number of inputs to the network, the number of layers in the network, the number of nodes in a layer, the learning rate for the network, and the momentum coefficient for the network. The plant component models discussed above provide a starting point for the selection of inputs for the neural network model. Specifically, these input data are: chilled water or hot water supply and return header temperatures, condenser water supply and return header temperatures, chiller plant or boiler plant load, chilled water or hot water flow, chiller or hot water boiler power, chilled water or hot water pump power (both primary and secondary pump KW), and air handler fan power. Additionally, building data and external data, such as outside air temperature, outside air dew point temperature; and plant equipment ratings improve the accuracy of the values generated by the network. As explained above, the optimization process requires use of a neural network working in tandem with a genetic algorithm. The training of the neural network is performed offline (FIG. 3) and is based on historical trend data from the site and external data such as utility rates and equipment ratings. As illustrated in FIG. 3, the neural network 40 is provided with data on its inputs 44 and the data on its outputs 48 are compared to target data by comparators 50. Any detected errors are used to further refine the neuron weights or other neural network design parameters.

Once the neural network is trained, it is then used to implement a system model 14 for making predictions of plant operating cost. These predictions are provided online to an objective function 18 and a genetic optimization engine 20. Preferably, the minimized plant operating cost is the objective function 18 for the system 10. A depiction of the system 10 implemented with a neural network is shown in FIG. 4.

In both a classical and artificial intelligence implementation of the system 10, the system model of the present invention may be coupled to the input data collector through an input for water supply and return temperatures an input for condenser water supply and return temperatures an input for thermal plant load an input for water flow, an input for water thermal treatment power, an input for water pump power, and an input for air handler fan power. These data are collected at a remote building site at some sampling frequency. Preferably, the sampling frequency is less than one hour. The data may be smoothed with a median or mean average filter.

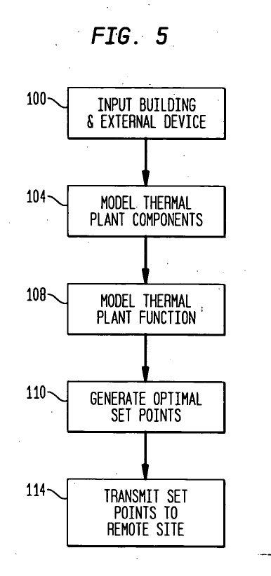

A method for optimizing global set points for a building environmental management system is shown in FIG. 5. The method begins by receiving building data and weather data (block 100) and modeling components of a thermal plant with the building and weather data (block 104). The responses of the modeled components are used by an objective function to model an operational parameter of the thermal plant (block 108), such as cost. The objective function and responses of the thermal plant components are used to optimize the set points generated by the modeled thermal plant components (block 110). These optimized set points may be transmitted to a remote building environmental management system (block 114) for incorporation in its operation. The method of the present invention may be used to model a chilled water plant or a hot water plant model.

The method of the present invention may be implemented using classical models or artificial intelligence models. Classical models are those models that are implemented using linear programming, unconstrained non-linear programming, or constrained non-linear programming methodologies. The artificial intelligence models are those models that may be implemented using a fuzzy expert control system with crisp and fuzzy rules, genetic algorithms for optimization, or neural networks. A preferred artificial intelligence model includes a neural network for modeling the thermal plant, the objective function for operating the thermal plant is a cost function, and the optimization engine implements a genetic algorithm for generating optimized set points for minimizing the cost operation of the thermal plant.

When a neural network is used to model the method of the present invention, the neural network is trained to model the thermal plant, an objective function of the plant, such as cost, is selected, and optimized set points for minimizing the operation of the thermal plant are generated. Alternatively, a fuzzy expert control system may be used to model the thermal plant. Preferably, a genetic algorithm is used to optimize the set points generated by the neural network or the fuzzy expert control system. The method of the present invention may generate optimized set points for a condenser water supply temperature, an output water supply temperature, and a coil dischargeair temperature, for example.

The receipt of building data used by the method of the present invention may also include inputting water supply and return temperatures, inputting condenser water supply and return temperatures, inputting thermal plant load, inputting water flow, inputting water thermal treatment power, inputting water pump power, and inputting air handler fan power. These data are used to generate characterization factors for the thermal plant components. Functional relationships are generated for the characterization factors and a building load, and the optimal global set points are generated with reference to the characterization factors and their corresponding functional relationships.

While the present invention has been illustrated by the description of exemplary processes and system components, and while the various processes and components have been described in considerable detail, applicants do not intend to restrict or in any way limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicants' general inventive concept.

1) A system for optimizing global set points for a building environmental management system comprising:
a system model for modeling components of a thermal plant;
an objective function for modeling a parameter of the thermal plant; and
an optimization engine for optimizing the parameter modeled by the objective function.

2) The system of claim 1 further comprising:
an input data collector for receiving building data and weather data, the input data collector being coupled to the system model.

3) The system of claim 1, the system model including:
a chilled water plant model.

4) The system of claim 1, the system model including:
a hot water plant model.

5) The system of claim 1 wherein the system model implements an unconstrained non-linear program to model the thermal plant.

6) The system of claim 1 wherein the system model being a neural network to model the thermal plant;
the objective function being a cost function for operating the thermal plant; and
the optimization engine is a genetic algorithm for generating optimized set points for minimizing the operation of the thermal plant.

7) The system of claim 1 wherein the system model being a fuzzy expert system to model the thermal plant;
the objective function being a cost function for operating the thermal plant; and
the optimization engine is a genetic algorithm for generating optimized set points for minimizing the operation of the thermal plant.

8) The system of claim 1 wherein the optimization engine generates a condenser water supply temperature, an output water supply temperature, and a coil discharge air temperature.

9) The system of claim 1 further comprising:
a transmitter for transmitting the global set points to a remote building environmental management system.

10) The system of claim 2, the input data collector further comprising:
an input for water supply and return temperatures;
an input for condenser water supply and return temperatures;
an input for thermal plant load;
an input for water flow;
an input for water thermal treatment power;
an input for water pump power; and
an input for air handler fan power.

11) The system of claim 10, the system model further comprising:
a plurality of component models, the component models generating characterization factors for the component models.

12) The system of claim 11 further comprising:
a regression analyzer for generating functional relationships between the generated-characterization factors and a building load; and
the optimization engine receiving the functional relationships for generating the optimal global set points.

13) A method for optimizing global set points for a building environmental management system comprising:
modeling components of a thermal plant;
modeling a parameter of the thermal plant; and
optimizing the parameter modeled by the objective function.

14) The method of claim 13 further comprising:
receiving building data and weather data; and
using the collected data for modeling the thermal plant components.

15) The method of claim 13, the thermal plant modeling including:
modeling a chilled water plant.

16) The method of claim 13, the thermal plant modeling including:
modeling a hot water plant model.

17) The method of claim 13, the thermal plant modeling including:
implementing an unconstrained non-linear program to model the thermal plant.

18) The method of claim 13, the thermal plant modeling including:
training a neural network to model the thermal plant;
selecting a cost function for the thermal plant parameter; and
generating with a genetic algorithm the optimized set points for minimizing the operation of the thermal plant.

19) The method of claim 13, the thermal plant modeling including:
model the thermal plant with a fuzzy logic system;
selecting a cost function for thermal plant parameter; and
generating with a genetic algorithm the optimized set points for minimizing the operation of the thermal plant.

20) The method of claim 13, the parameter optimization including:
generating a optimized set points for a condenser water supply temperature, an output water supply temperature, and a coil discharge air temperature.

21) The method of claim 13 further comprising:
transmitting the global set points to a remote building environmental management system.

22) The method of claim 13 further comprising:
inputting water supply and return temperatures;
inputting condenser water supply and return temperatures;
inputting thermal plant load;
inputting water flow;
inputting water thermal treatment power;
inputting water pump power; and
inputting air handler fan power.

23) The method of claim 22 further comprising:
generating characterization factors for the thermal plant components.

24) The method of claim 23 further comprising:
generating functional relationships between the generated characterization factors and a building load; and
generating the optimal global set points with reference to the generated characterization factors.
